(19) United States
(12) Patent Application Publication
(10) Pub. No.: US 2010/0005469 A1
(43) Pub. Date: Jan. 7, 2010

(54) Method and System for Defining One Flow Models with Varied Abstractions for Scalable lean Implementations

(75) Inventors: Abhijit Bose, Paramus, NJ (US); Huang-Yang Chang, Scarsdale, NY (US); Santhosh Babu Kumaran, Peekskill, NY (US); Arjun Natarjan, Old Tappan, NJ (US); Sreeram Ramakrishnan, Yorktown Heights, NY (US); Debanjan Saha, Mohegan Lake, NY (US); Ramendra K. Sahoo, Mohegan Lake, NY (US)

Correspondence Address: CAHN & SAMUELS, LLP, 1100 17th STREET, NW, SUITE 401, WASHINGTON, DC, 20036, US

(73) Assignee: INTERNATIONAL BUSINESS MACHINES CORPORATION, Armonk, NY (US)

(21) Appl. No.: 12/167,184

(22) Filed: Jul. 2, 2008

(51) Int. Cl. G06F 9/44

(52) U.S. Cl. 718/102

(57) ABSTRACT

A method and system for representing one or more families of existing processes in a composite abstraction such that process improvement techniques can be implemented in a more scalable manner. The invention enables abstracting a set of pre-defined process models into a composite model that represents sufficient operational details while being compliant with process improvement techniques such as, but not limited to, Lean Six Sigma, Kaizen, and others (collectively “lean” techniques). The invention provides the ability to flexibly represent the operational and lean-related information in varied abstraction levels at different stages of the process as and when necessary. The invention provides the ability to dynamically generate and represent process models based on user-selected defining characteristics (or attributes) used for process “family” formation. This allows users to define process models based on a set of customized attributes deemed critical by that particular user, including the ability to prioritize the selected attributes.

### FIELD OF THE INVENTION

This invention relates to a method and system for representing one or more families of existing processes in a composite abstraction such that process improvement techniques can be implemented in a more scalable manner.

### BACKGROUND OF THE INVENTION

In the areas of business and information technology (IT), various processes are utilized to develop, deliver and implement required or requested services. Organizations charged with these tasks often employ business improvement methodologies, such as Lean Six Sigma, Kaizen, and others, in an effort to improve the efficiency, quality and consistency of these processes and the corresponding process steps.

These methodologies are often implemented with process models that outline the tasks required for the services. These process models aim to divide or partition services into small, standardized components that can be quickly and efficiently assembled to deliver the services. However, these process models are quite rigid and lack flexibility and granularity. This lack of flexibility and granularity prevents abstract information from being obtained such that the information is compliant with improvement methodology analyses, e.g., lean analysis (by providing required attributes and associated key performance indicators (KPIs), while simultaneously being able to represent the abstracted model in a composite manner. These limitations prevent the ability to represent varied granularities in the same process model that is compliant with lean analysis.

Consider, for example, a set of processes for which Lean Six Sigma analysis needs to be performed. Traditionally, the analysis process would perform value stream mapping and associated methods to each one of these processes individually. These steps necessitate increased time, effort and costs.

### SUMMARY OF THE INVENTION

In at least one embodiment, the present invention provides a method including receiving a set of existing processes; selecting groups of processes within said set of existing processes to consider for defining process flows; organizing said selected groups of processes based on common subsets of attributes; enriching said selected groups of processes to be compatible with process improvement techniques; forming at least one process platform from said selected groups of processes; and adding at least one key performance indicator to said at least one process platform.

In at least another embodiment, the present invention provides a system including means for receiving a set of existing processes; means for selecting groups of processes within said set of existing processes to consider for defining process flows; means for organizing said selected groups of processes based on common subsets of attributes; means for enriching said selected groups of processes to be compatible with process improvement techniques; means for forming at least one process platform from said selected groups of processes; and means for adding at least one key performance indicator to said at least one process platform.

In at least another embodiment, the present invention provides a computer program product comprising a computer useable medium including a computer readable program, wherein the computer readable program when executed on a computer causes the computer to receive a set of existing processes; select groups of processes within said set of existing processes to consider for defining process flows; organize said selected groups of processes based on common subsets of attributes; enrich said selected groups of processes to be compatible with process improvement techniques; form at least one process platform from related groups of processes; and add at least one key performance indicator to said at least one process platform.

In at least another embodiment, the present invention provides a method including receiving at least one set of business processes; selecting at least one group of processes within said at least one set of business processes to consider for defining process flows; assigning commonality definitions to said at least one group of selected processes; assigning lean requirements to said at least one group of selected processes; integrating said commonality definitions and said lean requirement to make said at least one group of selected processes compatible with process improvement techniques; forming at least one process platform from said at least one group of selected processes; adding at least one key performance indicator to said at least one process platform; creating at least one optimized process platform from said at least one process platform and said key performance indicators; and integrating lean process methodologies and tools into said optimized platform to create at least one lean compliant process platform.

### BRIEF DESCRIPTION OF THE DRAWINGS

The present invention is described with reference to the accompanying drawings, wherein:

FIG. 1 illustrates a flow chart outlining an overview of the process in accordance with an exemplary embodiment of the present invention.

FIG. 2 illustrates a flow chart outlining an overview of the relationship between the process elements of an exemplary embodiment of the present invention.

FIGS. 3A-3B illustrate exemplary processes for identifying and partitioning common tasks of an exemplary embodiment of the present invention.

FIG. 4 illustrates a process workflow as practiced with an exemplary embodiment of the present invention.

FIG. 5 illustrates a process workflow commonality matrix as practiced with an exemplary embodiment of the present invention.

FIG. 6 illustrates a process task workflow in accordance with an exemplary embodiment of the present invention.

FIGS. 7A-7C illustrate commonality matrix task workflows in accordance with an exemplary embodiment of the present invention.

Given the following enabling description of the drawings, the apparatus should become evident to a person of ordinary skill in the art.

### DETAILED DESCRIPTION OF THE DRAWINGS

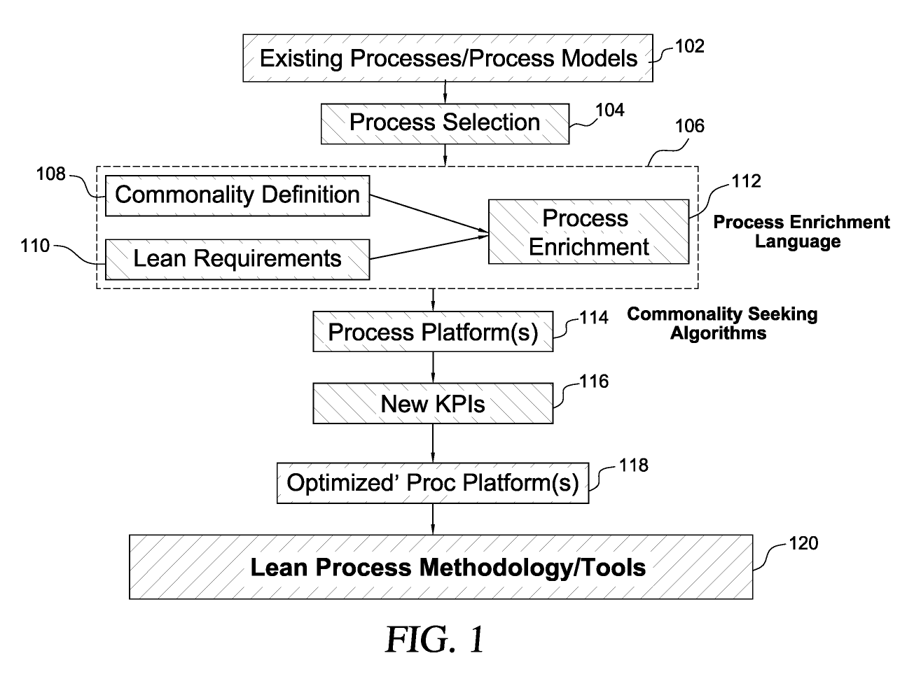

The present invention will be described in an information technology (IT) services environment and its advantages are best understood by referring to FIGS. 1-7C. In the IT services environment, requested or required services (or processes) may be developed, delivered and implemented by integrating known component processes of a process model. In at least one embodiment, the present invention describes a method for abstracting a set of pre-defined process models into a composite model that represents sufficient operational details while being compliant with process improvement techniques such as, but not limited to, Lean Six Sigma, Kaizen, and others (collectively “lean” techniques).

In at least one embodiment, the present invention provides the ability to flexibly represent the operational and lean-related information in varied abstraction levels at different stages of the process as and when necessary. In at least one embodiment, the present invention also provides the ability to dynamically generate and represent process models by choosing the defining characteristics (or attributes) used for process “family” formation. This aspect allows similar processes to be defined or grouped into “families” based upon preferences provided by subject matter experts. As a result, the present invention allows users to define process models based on a set of customized attributes deemed critical by that particular user, including the ability to prioritize the selected attributes. The present invention is referred to and described herein with respect to the One Flow Model (OFM) representation. However, this disclosure is not intended to be limited to use with the OFM but can be used with other similar process model techniques which also fall within the scope of the disclosure.

FIG. 1 illustrates an example of the method of the present invention. This method identifies the family of processes that need to be abstracted into process models, such as OFMs, thereby allowing process improvement techniques to be implemented in a flexible and scalable manner. The method begins by receiving a set of existing processes or process models, e.g., business process models, at 102. At 104, the method identifies and selects the groups or families of processes that need to be considered for defining the OFMs. These families are abstracted into the OFM in order to facilitate the implementation of lean techniques in a scalable manner. At 106, the method identifies the sub-set of attributes that need to be considered for defining family formation. The sub-set of attributes is defined based on specific objectives of the process improvement techniques adopted for the process families. At 108, the method identifies and assigns common definitions for process families and outputs the common definitions to the process enrichment module at 112. At 110, the method identifies lean requirements consistent with the process improvement technique adopted to remove non-value added aspects of the process representation and outputs the representation to the process enrichment module at 112. At 112, the method integrates the commonality definitions and lean requirements, and allows the user to add characteristics and details that enrich the attribute sub-sets (or feature vectors). At 114, the families of related processes are formed. These families define the process platform(s) that serve as the backbone of the process. Commonality seeking algorithms may also be used to identify and aggregate commonalities processes and to further define the process platform(s). At 116, new key performance indicators (KPIs) or metrics are added to from the process platform(s). New KPIs or metrics may also be derived from the process platform. At 118, optimized process platform(s) are produced from the process platform(s) and new KPIs/metrics. At 120, lean process methodologies and tools are integrated into the optimized process platform(s) that enable the optimized process platform(s) to be scalably delivered to other business processes such that flexibility and granularity of the process models is achieved.

Commonality definition 108, lean requirements 110, and process enrichment 112 are specific attributes or constraints that can be imposed in a particular instantiation of the method. Commonality definition 108 lists the specific attributes a user wants to form the basis for the process family formation. These attributes form the basis for the commonality seeking algorithms that will define the process families. For example, in the IT delivery/maintenance environment, these attributes might include dimensions such as operating platform, database type, etc. Lean requirements 110 provide a set of lean-related metrics that can be used to define the process families. Lean requirements 110 enable a user to incorporate desired control metrics or other descriptors into any of the process families that will be defined by the system. These metrics can be resource-centric traditional lean metrics, such as utilization rates, throughput, mean service times, error rates and recovery, or people-centric metrics, such as learning curves. Commonality definition 108 and lean requirements 110 are both user-specific inputs. Commonality definition 108 provides the dimensions for defining and developing process families, while lean requirements 110 provide the attributes that need to be enriched in the process models.

Once the desired set of attributes, i.e., commonality definition 108, for forming the process families and the desired metrics, i.e., lean requirements 110, are identified, the process performs process enrichment 112. Process enrichment 112 is the process of adding notations to the process descriptors—in addition to traditional descriptors, such as “Who”, “What”, “When”, “How”, and “Where”—based on the selected attributes in commonality definition 108 and lean requirement 110. The enriched process (process descriptions with additional notations to account for user selections in 108 and 110) form the basis for the commonality seeking algorithms 114.

Process enrichment 112, in at least one embodiment includes attribute partitioning based on various aspects of the commonality definition 108 and lean requirement 110, as well as potential abstractions to consider. Attribute partitioning aspects may include, for example, (i) descriptive process characterization attributes including visual syntax and logic for logic programming such as Hammer's notation, (ii) descriptive performance attributes such as process key performance indicators (KPIs) and metrics, and process family formation attributes such as platform, operating system, tools, or technologies. Potential abstractions to consider include logical service flows and physical service flows.

The formation of process families, 114, utilizes methods that outline the defining characteristics of the process, i.e., define “Who”, “What”, “When”, “How”, and “Where”. These characteristics may include identification of platforms such as Intel or Unix, identification of technologies such as Windows, Solaris or AIX, identification of tools such as Oracle database server, and identification of skill sets of role players and subject matter experts. These characteristics allow the subject matter experts to prioritize the characteristics for a particular logical cluster. Known data analysis techniques, such as principal component analysis (PCA) or in some cases independent component analysis (ICA), may also be used to define the attributes that identify the commonalities of characteristics.

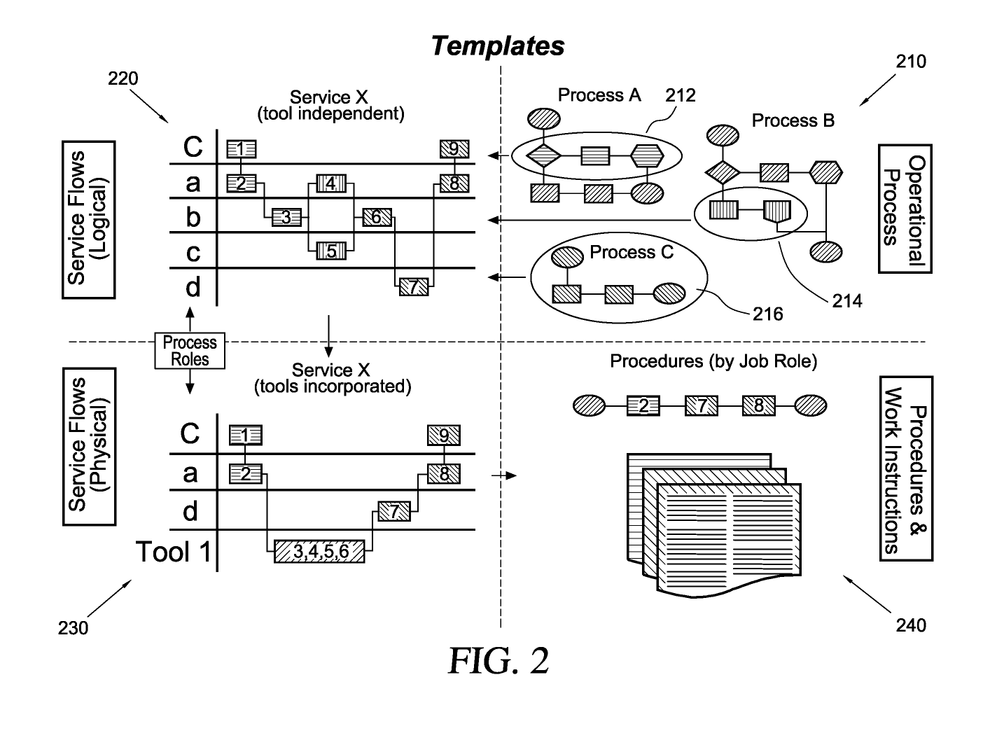

FIG. 2 illustrates a representation of the process element relationship of a business process according to an exemplary implementation of the present invention. FIG. 2 outlines the interrelationship of the various elements of the process, including operational processes 210, logical service flows 220, physical service flows 230, and procedures and work instructions 240. After receiving a service request, the method begins searching the groups or families of operational processes 210, including for example, Process A, Process B and Process C, to be considered for defining the required process models. The method identifies and selects groups of task sub-sets 212, 214 and 216 from Process A, Process B and Process C, respectively, for defining the logical service flows. At 220, logical service flows are formed by integrating sub-sets 212, 214 and 216 into an ordered (numbered) task flow that includes tasks 1-9. The logical service flows 220 are formed without regard for the tools required for implementation. At 230, physical service flows are formed by incorporating the tools required to perform the tasks 1-9 into the logical service flows 220. At 240, procedures and work instructions required to perfume the tasks 1-9 are formed based on the service provider's job role.

The combination of tasks 3, 4, 5, 6 in the physical service flows 230 is not intended to suggest a consolidation of these tasks. This representation is intended to highlight that the common tool (Tool 1) for these tasks may identify an opportunity for defining family formations and/or an opportunity for leaning the process. Identifying common tasks in order to target family formation and lean the new composite process enables leaning at a scale that impacts a cluster of process tasks instead of performing lean processes on the tasks individually. As a result, one level of lean may potentially address the common process tasks, and enable a second level of lean to focus on the unique tasks. Performing lean operations in such a scaled fashion promotes greater process efficiency.

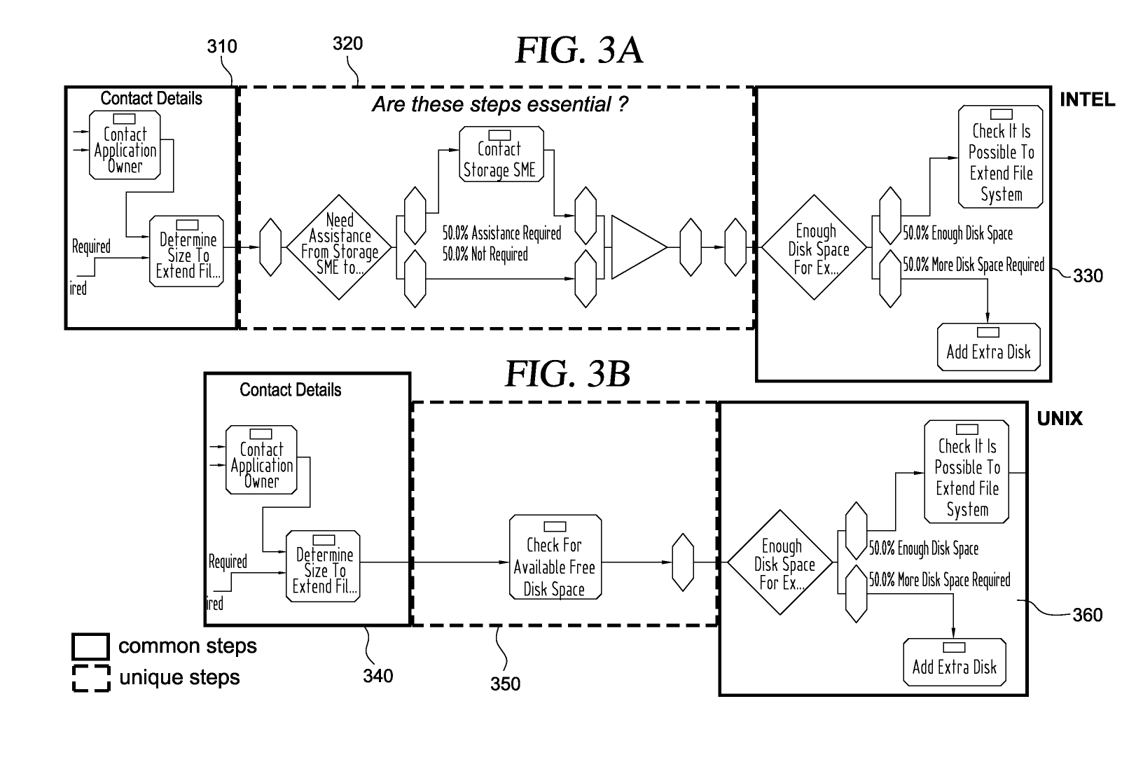

In at least one embodiment, the method of the present invention defines the tasks required for service delivery based on commonality of tasks in order to make the tasks more generic such that the tasks and associated work flows function with multiple platforms, technologies, tools and skill sets. FIGS. 3A-3B illustrate the steps of related Intel and UNIX processes, respectively. The illustrated method identifies and partitions common steps in the processes in order to lean those steps. The method recognizes that the steps shown at 310 and 340 are common steps. The method also recognizes that the steps shown at 330 and 360 are common steps. The method partitions all common steps for leaning. The method also recognizes that the steps shown at 320 and 350 are not common. The method then determines whether the uncommon steps are essential to the process. If the uncommon steps are not essential to the process, the method eliminates that step from the process and proceeds with the leaning process. If the uncommon steps are essential to the process, the method leaves those steps in the process and proceeds with the leaning process.

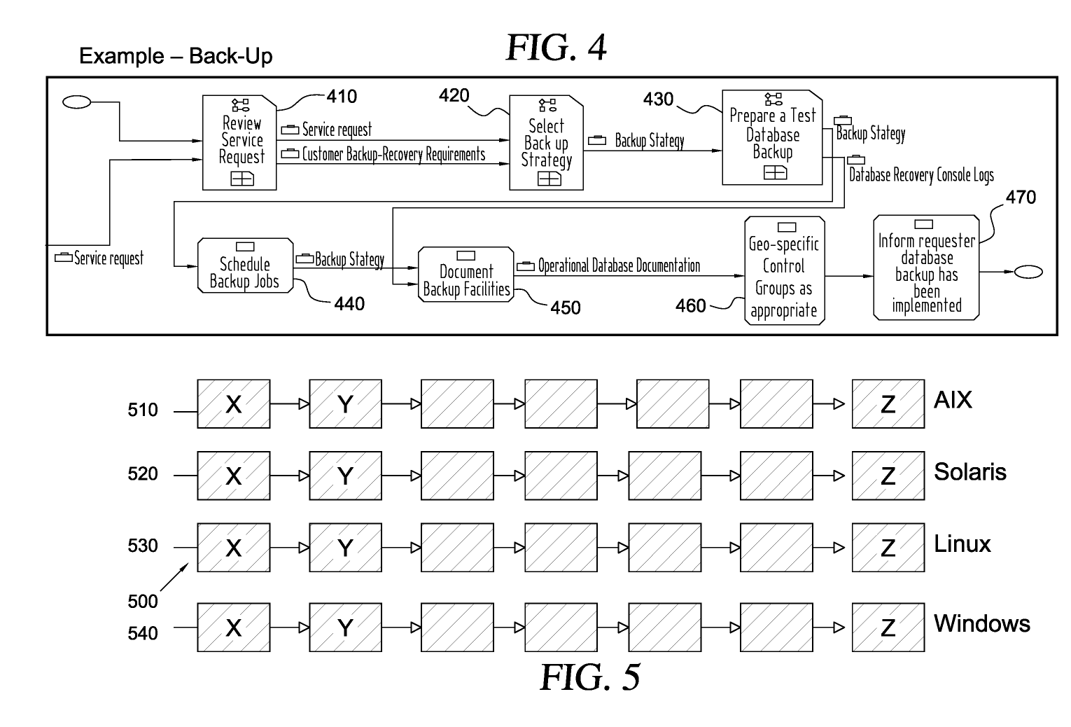

FIGS. 4-7C illustrate related process steps according to an example of the present invention. FIG. 4 outlines an exemplary high-level work flow process prior to leaning that is suitable for use with the present invention. Work flow process 400 represents an exemplary service request for a database backup. At 410, the service request is reviewed and output to the backup strategy selection module 430 along with any customer specific requirements. At 420, a backup strategy is selected and outputted to the database backup preparation and testing module 430. At 430, the database backup is prepared and tested. The backup strategy is outputted to backup jobs scheduler 440, while the database recovery console logs are output to document backup facilities 450. At 440, backup jobs scheduler outputs the backup strategy to document backup facilities 450. At 450, document backup facilities outputs operational database documentation. At 460, geographic specific control groups are implemented (as appropriate). At 470, the requester is informed that the database backup has been implemented.

FIG. 5 illustrates a commonality matrix outlining steps of an example of the present invention. The commonality matrix 500 represents the steps required by each operating system platform for performing the same objective, i.e., database backup process, discussed with respect to FIG. 4. The illustrated operating system platforms include AIX, Solaris, Linux and Windows. Each operating system may require steps specific to that operating system. However, steps common to all the operating systems may also exist. Therefore, there each operating system will have a customized process model for achieving the same objective, i.e., database backup.

In at least one embodiment, the present invention provides a means of consolidating the best practices into a one-flow model (OFM). The steps required by the AIX process are outlined at 5 10. The steps required by the Solaris process are outlined at 520. The steps required by the Linux process are outlined at 530. The steps required by the Windows process are outlined at 540. The matrix 500 shows that the first two steps (X and Y) of each platform 510-540 are common. In this example, the steps of database backup process are outlined for each of the platforms and the associated specific backup process models. The commonality matrix formation allows for some of the steps of the process to be regrouped or compressed to yield a composite chart. Once the commonality seeking algorithms run, the commonalities in the first two stages are identified and aggregated. The remaining stages may or may not have commonalities defined for the same platform. In this example, the operating system is the primary dimension that defines the commonality across the different process models. Based on this dimension the user is able to better understand the common tasks associated with the database backup request across all operating systems and define an OFM that affords increased customizability.

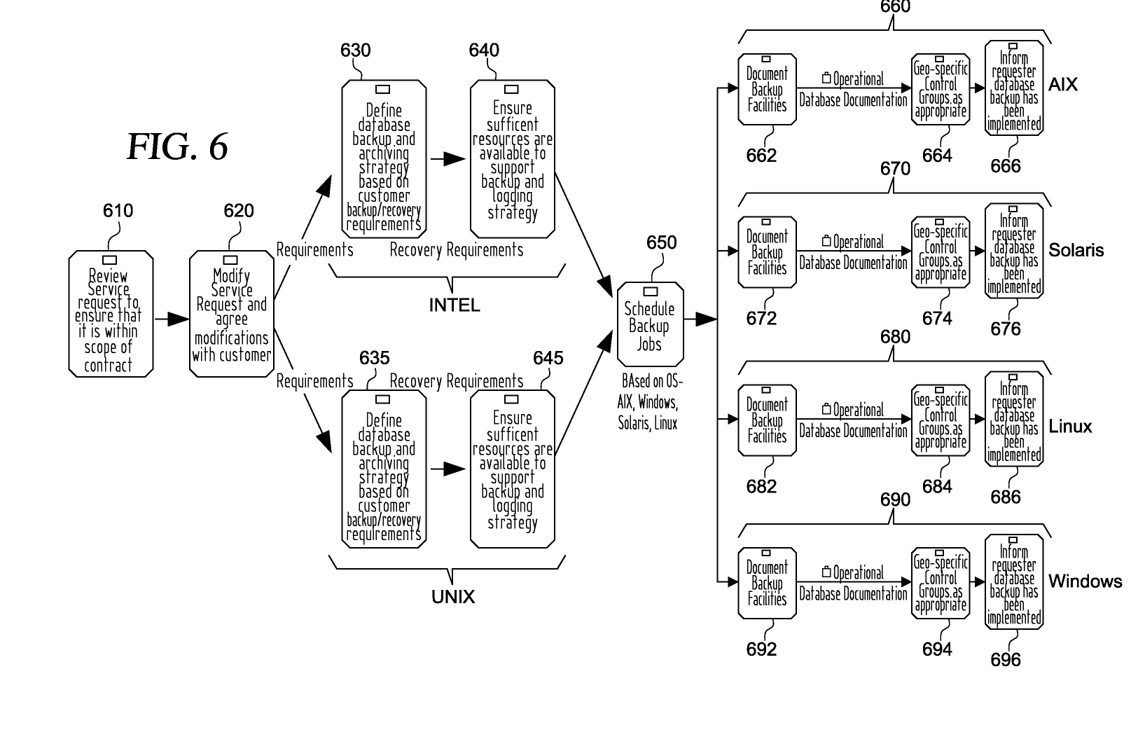

FIG. 6 illustrates an exemplary task flow for performing the database backup process for each operating system platform. Specific backup process models exist for different platform architectures. Common tasks in the matrix are compressed to simplify the backup process. FIG. 6 illustrates how the use of a discriminating dimension (Intel versus UNIX) changes the process models. The exemplary database backup process begins at 610. At 610, the service request is review to ensure that the requested services are within the scope of the contract. At 620, the service request is modified to ensure compliance with customer requirements. The next two steps are bifurcated at an increased level of granularity in order to provide the detail required to ensure process compliance with different architecture platforms, e.g., Intel and UNIX. Steps 630 and 640 define tasks required by the process in an Intel architecture platform. Steps 635 and 645 define tasks required by the process in a UNIX architecture platform. At 630, the method defines the database backup and requirements archiving strategy based on customer backup and recovery requirements when using an Intel platform. At 640, the method ensures that sufficient resources are available to support backup and logging strategies using an Intel platform. At 635, the method defines the database backup and requirements archiving strategy based on customer backup and recovery requirements using a UNIX platform. At 645, the method ensures that sufficient resources are available to support backup and logging strategies using a UNIX platform. At 650, the method schedules the backup jobs. After the backup jobs are scheduled, the jobs are performed based on the specific operating system processes.

660-690 outline a composite representation of the operational steps required for the various operating systems. At 660, the database backup job is performed in the AIX environment based on the steps 662-666 required by the AIX operating system. At 670, the database backup job is performed in the Solaris environment based on the steps 672-676 required by the Solaris operating system. At 680, the database backup job is performed in the Linux environment based on the steps 682-686 required by the Linux operating system. At 690, the database backup job is performed in the Windows environment based on the steps 692-696 required by the Windows operating system.

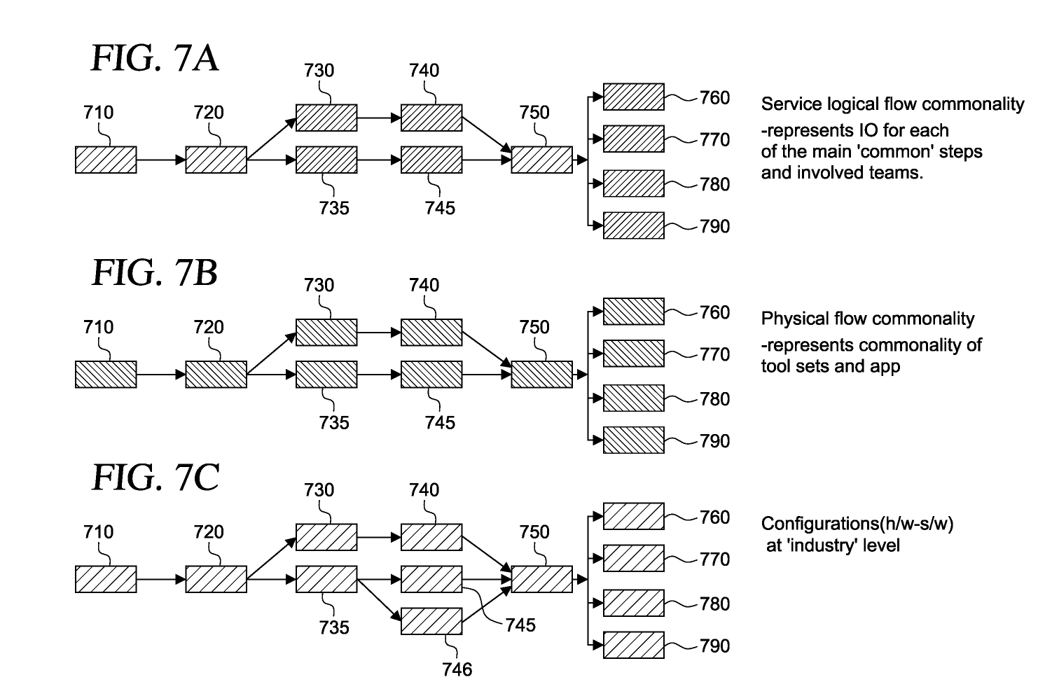

FIGS. 7A-7C illustrate exemplary representations of compressed commonality matrix flows for the backup process outlined with respect to FIG. 6. FIGS. 7A-7C detail the steps of the compressed commonality matrix for the backup process at varying levels of granularity. FIGS. 7A-7C outline the operational configuration of the compressed task flow for the backup process. The operational configuration profiles the common tasks for the logical service flow steps, the physical service flow steps, and the hardware/software configuration flow steps. FIG. 7A details the logical service flow steps of the compressed commonality matrix for the backup process. The logical service flow represents the input/output for each of the main “common” steps and involved teams. FIG. 7B details the physical service flow steps of the compressed commonality matrix for the backup process. The physical service flow represents the commonality of tools and applications required. FIG. 7C details the hardware/software configuration flow of the compressed commonality matrix for the backup process. This flow represents the hardware/software configurations and steps required at the implementation (or industry) level. Platform specific steps 730-740 and 735-746 for each flow are detailed at increased levels of granularity in order to meet the required level of detail for Intel and UNIX architecture platforms, respectively. For example, darker colors (shown with cross-hatching) may be utilized to represent enrichments, in this instance, with respect to platform specific process steps. Operating system specific steps 760-790 for each flow, similar to those outlined with respect to FIG. 6, are included.

The invention can take the form of an entirely hardware embodiment, an entirely software embodiment or an embodiment containing both hardware and software elements. In at least one exemplary embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As will be appreciated by one of ordinary skill in the art, the present invention may be embodied as a computer implemented method, a programmed computer, a data processing system, a signal, and/or computer program. Accordingly, the present invention may take the form of an entirely hardware embodiment, an entirely software embodiment or an embodiment combining software and hardware aspects. Furthermore, the present invention may take the form of a computer program on a computer-usable storage medium having computer-usable program code embodied in the medium. Any suitable computer readable medium may be utilized including hard disks, CD-ROMs, optical storage devices, carrier signals/waves, or other storage devices.

Computer program code for carrying out operations of the present invention may be written in a variety of computer programming languages. The program code may be executed entirely on at least one computing device, as a stand-alone software package, or it may be executed partly on one computing device and partly on a remote computer. In the latter scenario, the remote computer may be connected directly to the one computing device via a LAN or a WAN (for example, Intranet), or the connection may be made indirectly through an external computer (for example, through the Internet, a secure network, a sneaker net, or some combination of these).

It will be understood that each block of the flowchart illustrations and block diagrams and combinations of those blocks can be implemented by computer program instructions and/or means. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowcharts or block diagrams.

The exemplary and alternative embodiments described above may be combined in a variety of ways with each other. Furthermore, the steps and number of the various steps illustrated in the figures may be adjusted from that shown.

It should be noted that the present invention may, however, be embodied in many different forms and should not be construed as limited to the embodiments set forth herein; rather, the embodiments set forth herein are provided so that the disclosure will be thorough and complete, and will fully convey the scope of the invention to those skilled in the art. The accompanying drawings illustrate exemplary embodiments of the invention.

Although the present invention has been described in terms of particular exemplary and alternative embodiments, it is not limited to those embodiments. Alternative embodiments, examples, and modifications which would still be encompassed by the invention may be made by those skilled in the art, particularly in light of the foregoing teachings.

Those skilled in the art will appreciate that various adaptations and modifications of the exemplary and alternative embodiments described above can be configured without departing from the scope and spirit of the invention. Therefore, it is to be understood that, within the scope of the appended claims, the invention may be practiced other than as specifically described herein.

We claim:

1. A method, comprising:
receiving a set of existing processes;
selecting groups of processes within said set of existing processes to consider for defining process flows;
organizing said selected groups of processes based on common subsets of attributes;
enriching said selected groups of processes to be compatible with process improvement techniques;
forming at least one process platform from said selected groups of processes; and
adding at least one key performance indicator to said at least one process platform.

2. The method according to claim 1, further comprising creating at least one optimized process platform from said at least one process platform and said key performance indicators.

3. The method according to claim 1, wherein said set of existing processes include at least one business process.

4. The method according to claim 1, wherein enriching said selected groups of processes includes assigning common definitions to said organized groups.

5. The method according to claim 1, wherein enriching said selected groups of processes includes identifying requirements consistent with process improvement techniques.

6. The method according to claim 5, wherein said process improvement techniques include Lean Six Sigma processes or Kaizen processes.

7. The method according to claim 1, wherein enriching said selected groups of processes includes adding attributes and details to said organized groups.

8. A system, comprising:
means for receiving a set of existing processes;
means for selecting groups of processes within said set of existing processes to consider for defining process flows;
means for organizing said selected groups of processes based on common subsets of attributes;
means for enriching said selected groups of processes to be compatible with process improvement techniques;
means for forming at least one process platform from said selected groups of processes; and
means for adding at least one key performance indicator to said at least one process platform.

9. The system according to claim 8, wherein said set of existing processes include at least one business process.

10. The system according to claim 8, wherein said means for enriching said selected groups of processes includes means for assigning common definitions to said organized groups.

11. The system according to claim 8, wherein said means for enriching said selected groups of processes includes means for identifying requirements consistent with process improvement techniques.

12. The system according to claim 11, wherein said process improvement techniques include Lean Six Sigma processes or Kaizen processes.

13. The system according to claim 8, wherein means for enriching said selected groups of processes includes means for adding attributes and details to said organized groups.

14. A computer program product comprising a computer useable medium including a computer readable program, wherein the computer readable program when executed on a computer causes the computer to:
receive a set of existing processes;
select groups of processes within said set of existing processes to consider for defining process flows;
organize said selected groups of processes based on common subsets of attributes;
enrich said selected groups of processes to be compatible with process improvement techniques;
form at least one process platform from related groups of processes; and
add at least one key performance indicator to said at least one process platform.

15. A computer program product according to claim 14, wherein the computer readable program further causes the computer to:
create at least one optimized process platform from said at least one process platform and said key performance indicators.

16. A computer program product according to claim 14, wherein said set of existing processes include at least one business process.

17. A computer program product according to claim 14, wherein enriching said selected groups of processes further causes the computer readable program to cause the computer to:
assign common definitions to said organized groups.

18. A computer program product according to claim 14, wherein enriching said selected groups of processes further causes the computer readable program to cause the computer to:
identify requirements consistent with process improvement techniques.

19. A computer program product according to claim 18, wherein said process improvement techniques include Lean Six Sigma processes or Kaizen processes.

20. A computer program product according to claim 14, wherein enriching said selected groups of processes further causes the computer readable program to cause the computer to:
add attributes and details to said organized groups.

21. A method, comprising:
receiving at least one set of business processes;
selecting at least one group of processes within said at least one set of business processes to consider for defining process flows;
assigning commonality definitions to said at least one group of selected processes;
assigning lean requirements to said at least one group of selected processes;
integrating said commonality definitions and said lean requirement to make said at least one group of selected processes compatible with process improvement techniques;
forming at least one process platform from said at least one group of selected processes;
adding at least one key performance indicator to said at least one process platform;
creating at least one optimized process platform from said at least one process platform and said key performance indicators; and
integrating lean process methodologies and tools into said optimized platform to create at least one lean compliant process platform.

22. The method according to claim 21, wherein said at least one set of business processes are operational processes.

23. The method according to claim 21, wherein selecting at least one group of processes further includes:
identifying and selecting at least one group of task sub-sets within said at least one group of processes for defining at least one logical service flow;
forming said at least one logical service flow by integrating said task sub-sets into an ordered task flow;
forming at least one physical task flow by partitioning the tasks of said ordered task flow based on common requirements for performing said tasks; and
forming procedures for performing the tasks of said at least one logical task flow based on service provider job roles.

24. The method according to claim 23, wherein said common requirements include at least one of platforms, technologies, tools and skill sets.

25. The method according to claim 23, wherein selecting at least one group of processes enables leaning.
